(19) United States
(12) Patent Application Publication
(10) Pub. No.: US 2003/0027115 A1
(43) Pub. Date: Feb. 6, 2003

(54) Help! was that a career limiting move? (board game for business + cd-rom)

(76) Inventors: Marjorie Brody, Elkins Park, PA (US); Pam Holland, Rydal, PA (US)

Correspondence Address: Miryam S. Roddy, Suite 8, 815 Greenwood Avenue, Jenkintown, PA, 19046, US

(21) Appl. No.: 09/849,825

(22) Filed: Aug. 1, 2001

(51) Int. Cl. G09B 19/00

(52) U.S. Cl. 434/219

(57) ABSTRACT

To the best of our knowledge there is no game—board game or CD-ROM—currently on the market that allows individuals to learn about professional behavior in a fun, interactive manner, Anyone who holds a job or is trying to obtain one will be able to benefit from this game. “Help! Was That a Career Limiting Move?” will be unlike any other learning tool previously used in business training settings, and will be the first game of its kind on the market.

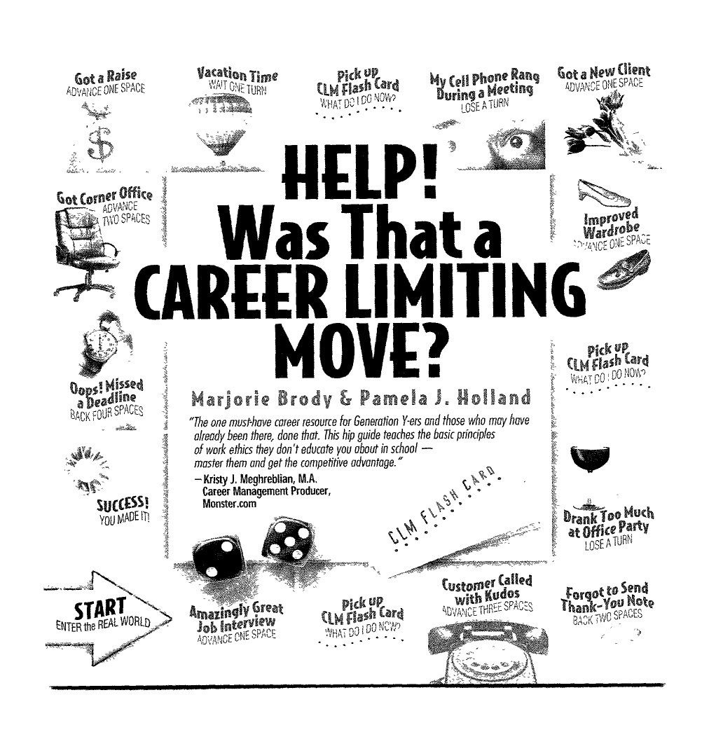

This patent application is for our proposed board game called Help! Was That a Career Limiting Move?

We intend to sell this board game to our existing client base of corporate accounts as well as to colleges and universities and anyone else—including everyday consumers and prospective clients—who may see a benefit to owning a copy. We also have plans to have our own Brody Communications Ltd. facilitators use the game during training or coaching programs.

The objective of the game—for single or multiple players—will be to make your way around the game board without encountering a potentially career-limiting behavior or situation. When a player does land on such a square, he or she will need to pick up a CLM card, and answer a question about what the appropriate response is to a potentially difficult business situation. When the CLM card is turned over, a tab pulled out, the correct answer is revealed. If answered correctly, the player advances. If not, the action described is taken (lose a turn, go back spaces). With multiple players, the game will be very interactive, as players can role-play situations and adapt their responses to various scenarios. Along the way, players will learn about real-life examples of etiquette gaffes, political snafus and business behavior blunders that have hurt professionals.

We also intend to market this game as computer software—a CD-ROM version of the board game.

How the products will be sold is as follows:

1) Through retail stores and college bookstores

2) Through our Web site

3) Through our newsletter

4) Through our training programs (possibly as part of our materials that are bought for each participant), coaching projects and speaking engagements

5) Through other eCommerce Web sites

At this time, we have not decided upon a price for either the board game or CD-ROM.

This patent application is for our proposed board game and CD-ROM called “Help! Was That a Career Limiting Move?” The game takes concepts and anecdotes from a similar named paperback book that came out September 7 and creates an interactive fun way to learn the do's and don'ts of the business world.

1. What we claim as our invention is an interactive CD-ROM and board game called “Help Was That a Career Limiting Move?” that will teach any level of professional—beginner or CEO—the appropriate business behaviors to practice in order to help them achieve career success. The objective of the game—for single or multiple players—will be to make your way around the game board without encountering a potentially career-ending behavior or situation. When a player does land on such a square, he or she will need to pick up a CLM card, and answer a question about what the appropriate response is to a potentially difficult business situation. When the CLM card is turned over or chosen, a tab pulled out, the correct answer is revealed. If answered correctly, the player advances. If not, the action described is taken (lose a turn, go back spaces). The game can be very interactive, as players can role-play situations and adapt their responses to various scenarios. Along the way, players will learn about real-life examples of etiquette gaffes and business behavior blunders that have hurt professionals.

2. We intend to sell this game to our existing client base of corporate accounts as well as to colleges and universities and anyone else—including everyday consumers and prospective clients—who may see a benefit to owning a copy—whether it's a CD-ROM or board game version that they purchase. Our own Brody Communications Ltd. facilitators may also choose to use the game during training or coaching programs.

3. How the products will be sold is as follows:
1) Through our Web site
2) Through our newsletter
3) Through our training programs (possibly as part of our materials that are bought for each participant), coaching projects and speaking engagements
4) Through other eCommerce Web sites
5) Through retail outlets and stores

4. At this time, we have not decided upon a price for either the board game or CD-ROM.
